(19) United States
(12) Patent Application Publication
(10) Pub. No.: US 2026/0019596 A1
(43) Pub. Date: Jan. 15, 2026

(54) LOW LEAKAGE ARCHITECTURE FOR VIDEO CODING

(71) Applicant: QUALCOMM Incorporated, San Diego, CA (US)

(72) Inventors: Shengqi Yang, Carlsbad, CA (US); Sai Kashyap Gobburi, Nalgonda (IN); Naveen Kumar Ponnusamy, Bangalore (IN)

(21) Appl. No.: 18/772,979

(22) Filed: Jul. 15, 2024

(51) Int. Cl. H04N 19/156; H04N 19/182; H04N 19/70

(52) U.S. Cl. CPC H04N 19/156; H04N 19/182; H04N 19/70

(57) ABSTRACT

A video encoder and video decoder may include a video syntax processing (VSP) engine configured to process the video data at a syntax element level, and a video pixel processing (VPP) engine configured to process the video data at a pixel level. The video encoder and video decoder may further include a controller configured to control a power of the VSP engine based on the VSP engine being idle.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for video encoding and decoding, including techniques for reducing power consumption in a video encoder and/or video decoder. In some examples, video codec cores may include two main processing engines: a Video Syntax Processing (VSP) engine, and a Video Pixel Processing engine (VPP) engine. The VSP engine may be configured to encode and decode syntax elements and includes processing engines to perform arithmetic coding, such as context adaptive binary arithmetic coding (CABAC). The VPP engine may be configured for pixel processing and may include engines for transforms, prediction, filtering, and other processes at the pixel level. In some examples, the power for each of the VSP engine and the VPP engine may be controlled individually in a video coding system. That is, the VSP engine and the VPP engine may be independently powered on and off.

The processing speed of a VSP engine is typically measured in terms of a bitrate (e.g., Mbps, M bits per second). However, the processing speed of a VPP engine is typically defined as a pixel rate (e.g., MPps, M Pixels per second). Typically, a CABAC engine, such as a VSP engine, is designed to handle a high bitrate, using design techniques such as multi-bins per cycle. A VSP engine typically processes data at a much faster rate than a VPP engine. Based on this difference in processing speeds, this disclosure describes techniques for efficiently powering off and on the VSP engine in various encoding and decoding scenarios. Such scenarios may include same frame encoding and decoding by the VSP engine and VPP engine, as well as different frame encoding and decoding by the VSP engine and the VPP engine. Because the VSP engine is able to run ahead of the VPP (or catch up), the VSP engine may be powered off when idle, or expected to be idle, to reduce leakage power loss.

In one example, a method includes processing, by a VSP engine, the video data at a syntax element level, processing, by a VPP engine, the video data at a pixel level, and controlling, by a controller, a power of the VSP engine based on the VSP engine being idle.

In another example, an apparatus includes a VSP engine configured to process the video data at a syntax element level, a VPP engine configured to process the video data at a pixel level, and a controller configured to control a power of the VSP engine based on the VSP engine being idle.

In another example, a device includes means for processing the video data at a syntax element level, means for processing the video data at a pixel level, and means for controlling a power of the means for processing the video data at a syntax element level based on the means for processing the video data at a syntax element level being idle.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 illustrates example use cases of a VSP engine and a VPP engine operating on the same frame of video data.

FIG. 5 illustrates example use cases of a VSP engine and a VPP engine operating on different frames of video data.

FIG. 6 is a block diagram illustrating an example video decoder in a same frame mode in accordance with one example of the disclosure.

FIG. 7 is a timing diagram illustrating an example of same frame video decoding in accordance with one example of the disclosure.

FIG. 8 is a flowchart illustrating an example of same frame video decoding in accordance with one example of the disclosure.

FIG. 9 is a block diagram illustrating an example video encoder in a same frame mode in accordance with one example of the disclosure.

FIG. 10 is a timing diagram illustrating an example of same frame video encoding in accordance with one example of the disclosure.

FIG. 11 is a flowchart illustrating an example of same frame video encoding in accordance with one example of the disclosure.

FIG. 12 is a block diagram illustrating an example video decoder in a different frame mode in accordance with one example of the disclosure.

FIG. 13 is a flowchart illustrating an example of different frame video decoding in accordance with one example of the disclosure.

FIG. 14 is a block diagram illustrating an example video encoder in a different frame mode in accordance with one example of the disclosure.

FIG. 15 is a flowchart illustrating an example of different frame video encoding in accordance with one example of the disclosure.

FIG. 16 is a flowchart illustrating an example method for coding video data in accordance with the techniques of this disclosure.

### DETAILED DESCRIPTION

Power consumption in a video codec processing core includes both dynamic power and leakage power. That is, the total power consumed in a combination of dynamic power (e.g., active processing), active leakage, and non-active leakage. Active leakage happens when the hardware is actively processing data, and may include current lost to ground. Non-active leakage also includes current lost to ground, but happens when the hardware is idle (e.g., is powered on, but is not actively processing data). As hardware designs become smaller and smaller (e.g., from 4nm to 3nm to 2nm), leakage becomes a larger portion of the total core power. Leakage may account for more than 25% of total power. Reducing leakage power becomes more and more important to controlling total core power.

In some examples, video codec cores may include two main processing engines: a Video Syntax Processing (VSP) engine, and a Video Pixel Processing engine (VPP) engine. The VSP engine may be configured to encode and decode syntax elements and includes processing engines to perform arithmetic coding, such as context adaptive binary arithmetic coding (CABAC). The VPP engine may be configured for pixel processing and may include engines for transforms, prediction, filtering, and other processes at the pixel level. In video decoding, the VSP engine may decode bins and syntax elements and prepares the block (or largest coding unit (LCU)) information, which is then used by the VPP engine to reconstruct the LCU pixels. In video encoding, the VSP engine consumes the syntax element information from the VPP for each LCU and compresses (e.g., using CABAC and other coding) the syntax information into bins. In some examples, the power for each of the VSP engine and the VPP engine may be controlled individually in a video coding system. That is, the VSP engine and the VPP engine may be independently powered on and off.

The processing speed of a VSP engine is typically measured in terms of a bitrate (e.g., Mbps, M bits per second). However, the processing speed of a VPP engine is typically defined as a pixel rate (e.g., MPps, M Pixels per second). Typically, a CABAC engine, such as a VSP engine, is designed to handle a high bitrate, using design techniques such as multi-bins per cycle. A VSP engine typically processes data at a much faster rate than a VPP engine. Based on this difference in processing speeds, this disclosure describes techniques for efficiently powering off and on the VSP engine in various encoding and decoding scenarios. Such scenarios may include same frame encoding and decoding by the VSP engine and VPP engine, as well as different frame encoding and decoding by the VSP engine and the VPP engine. Because the VSP engine is able to run ahead of the VPP (or catch up), the VSP engine may be powered off when idle, or expected to be idle, to reduce leakage power loss.

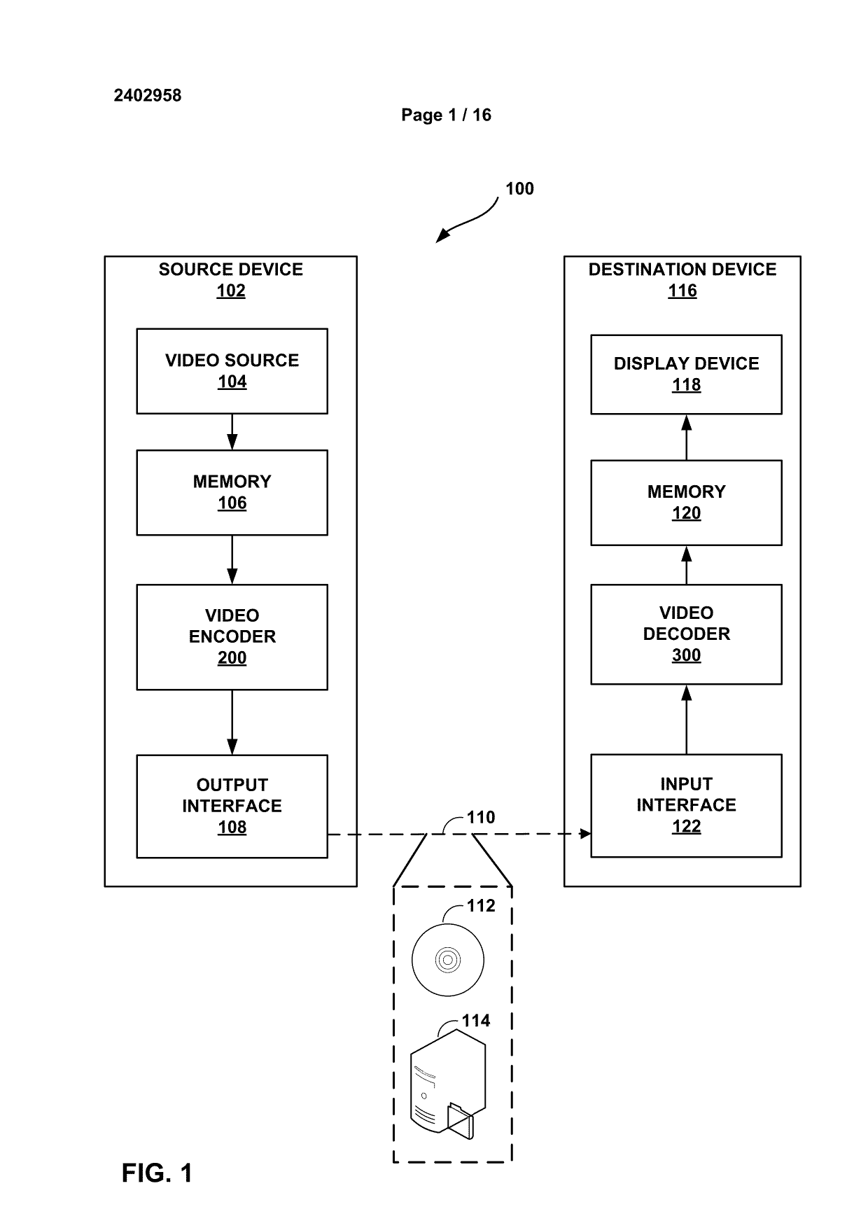

FIG. 1 is a block diagram illustrating an example video encoding and decoding system 100 that may perform the techniques of this disclosure. The techniques of this disclosure are generally directed to architectures for coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for coding video data using independently power controlled syntax and pixel processing engines. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for coding video data using independently power controlled syntax and pixel processing engines. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

As will be described in more detail below, video encoder 200 and video decoder 300 may each include a VSP engine and VPP engine. Video encoder 200 and video decoder 300 may each include a controller that may, among other things, independently control the on/off power state of the VSP engine and the VPP engine. In general, the VSP engine may be configured to process video data at the syntax element level, and may perform tasks such as entropy coding (e.g., CABAC). The VPP may be configured to process video data at the pixel level, and may perform task such as transform, prediction, and filtering.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that code video data using independently power controlled syntax and pixel processing engines.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128x128 luma samples or 64x64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2xN, NxN/2, N/4xN, and NxN/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an NxN block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an MxN block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “NxN” and “N by N” interchangeably to refer to the sample dimensions of a block (such as a CU or other video block) in terms of vertical and horizontal dimensions, e.g., 16x16 samples or 16 by 16 samples. In general, a 16x16 CU will have 16 samples in a vertical direction (y = 16) and 16 samples in a horizontal direction (x = 16). Likewise, an NxN CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include NxM samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

Power consumption in a video codec processing core includes both dynamic power and leakage power. That is, the total power consumed in a combination of dynamic power (e.g., active processing), active leakage, and non-active leakage. Active leakage happens when the hardware is actively processing data, and may include current lost to ground. Non-active leakage also includes current lost to ground, but happens when the hardware is idle (e.g., is powered on, but is not actively processing data). As hardware designs become smaller and smaller (e.g., from 4nm to 3nm to 2nm), leakage becomes a larger portion of the total core power. Leakage may account for more than 25% of total power. Reducing leakage power becomes more and more important to controlling total core power.

In some examples, video codec cores may include two main processing engines: a VSP engine, and a VPP engine. The VSP engine may be configured to encode and decode syntax elements and includes processing engines to perform arithmetic coding, such as CABAC. The VPP engine may be configured for pixel processing and may include engines for transforms, prediction, filtering, and other processes at the pixel level. In video decoding, the VSP engine may decode bins and syntax elements and prepares the block (or LCU) information, which is then used by the VPP engine to reconstruct the LCU pixels. In video encoding, the VSP engine consumes the syntax element information from the VPP for each LCU and compresses (e.g., using CABAC and other coding) the syntax information into bins. In some examples, the power for each of the VSP engine and the VPP engine may be controlled individually in a video coding system. That is, the VSP engine and the VPP engine may be independently powered on and off.

The processing speed of a VSP engine is typically measured in terms of a bitrate (e.g., Mbps, M bits per second). However, the processing speed of a VPP engine is typically defined as a pixel rate (e.g., MPps, M Pixels per second). Typically, a CABAC engine, such as a VSP engine, is designed to handle a high bitrate, using design techniques such as multi-bins per cycle. A VSP engine typically processes data at a much faster rate than a VPP engine. In some examples, a VSP engine may process data up to 3 times or 4 times faster than a VPP engine. Based on this difference in processing speeds, this disclosure describes techniques for efficiently powering off and on the VSP engine in various encoding and decoding scenarios. Such scenarios may include same frame encoding and decoding by the VSP engine and VPP engine, as well as different frame encoding and decoding by the VSP engine and the VPP engine. Because the VSP engine is able to run ahead of the VPP (or catch up), the VSP engine may be powered off when idle, or expected to be idle, to reduce leakage power loss. Reducing leakage power loss, including non-active leaking power loss, may be particularly beneficial for battery-powered devices that may have high power demands. Some example tests have shown power savings up to 5mW, which is significant for battery-powered devices. Such devices may include mobile communications devices, such as smartphones, tablets, laptops, virtual reality (VR) headsets, extended reality (XR) headsets, and/or augmented reality (AR) headsets.

In accordance with the techniques of this disclosure, as will be explained in more detail below, video encoder 200 and video decoder 300 may be configured to process, by a VSP engine, the video data at a syntax element level, process, by a VPP engine, the video data at a pixel level, and control, by a controller, a power of the VSP engine based on the VSP engine being idle.

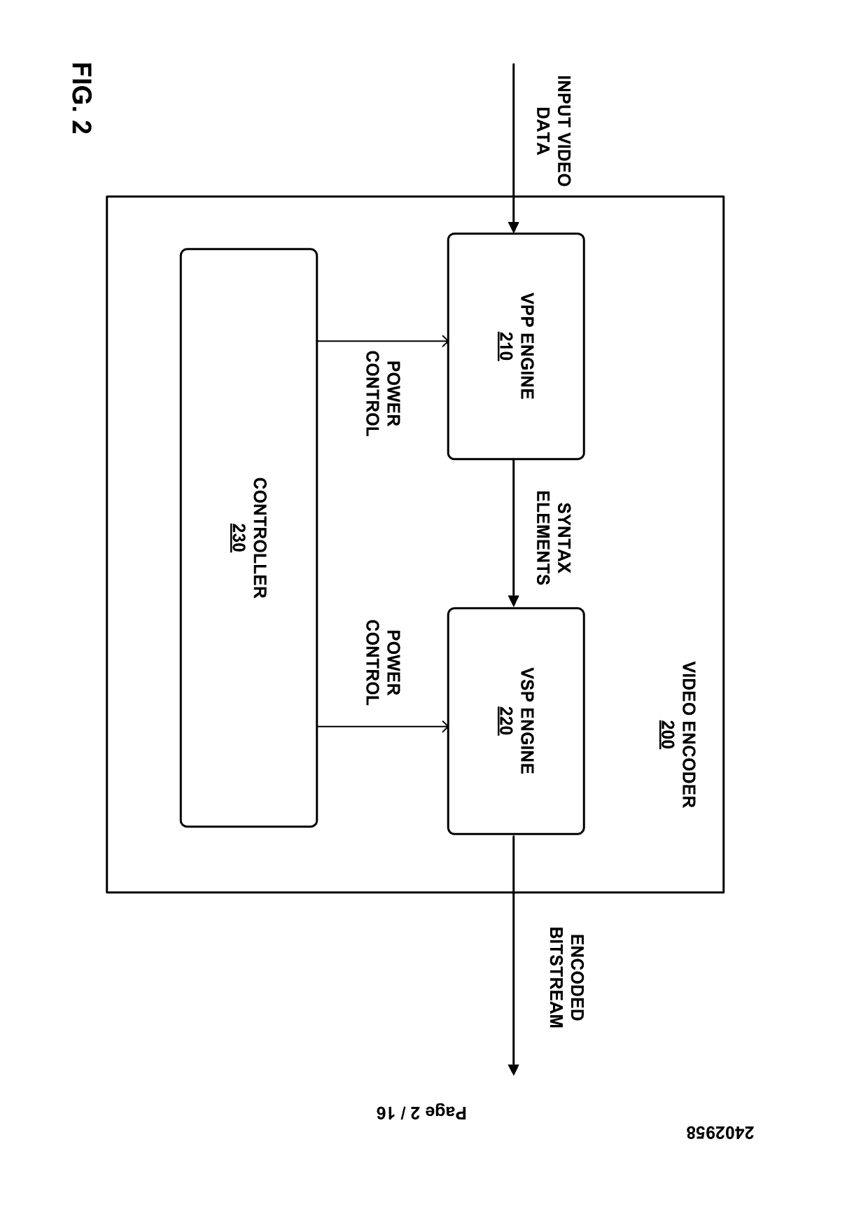

FIG. 2 is a block diagram illustrating an example video encoder that may perform the techniques of this disclosure. In the example of FIG. 2, video encoder 200 includes VPP engine 210, VSP engine 220, and controller 230. VPP engine 210 is configured to process input video data (e.g., frames of video data). In some examples, video encoder 200 may include a plurality of VPP engines, where the plurality of VPP engines may be configured to operate on video data of a frame in parallel. For example, each VPP engine may operate on an LCU row of video data.

As mentioned above, VPP engine 210 may process video data at the pixel level. As such, the processing speed of VPP engine 210 may be described as a pixel rate (e.g., MPps, M Pixels per second). VPP engine 210 may perform pixel level video encoding processes described above, such as prediction, transformation, quantization, filtering, and related processing for reconstructing reference frames. The output of VPP engine 210 is syntax elements.

VSP engine 220 takes the syntax elements as input and compresses the syntax elements to produce an encoded video bitstream. VSP engine 220 may compress the syntax elements using CABAC, other entropy coding techniques, and/or fixed probability encoding techniques. VSP engine 220 operates on the bit or “bin” level. The processing speed of VSP engine 220 engine is typically measured in terms of a bitrate (e.g., Mbps, M bits per second). Again, VSP engine 220 is typically configured to operate at a faster speed than VPP engine 210. VPP engine 210 and VSP engine 220 may exchange data through one or more memories or buffers, including faster on-chip buffers, or buffers in external memory (e.g., double data rate (DDR) RAM).

Video encoder 200 may further include a controller 230 configured to control the power state of VPP engine 210 and VSP engine 220. Controller 230 may operate according to firmware and/or may execute a software driver. As described above, controller 230 may be configured to independently power on and off VPP engine 210 and VSP engine 220. The techniques described below focus on how VSP engine 220 may be selectively powered off when idle.

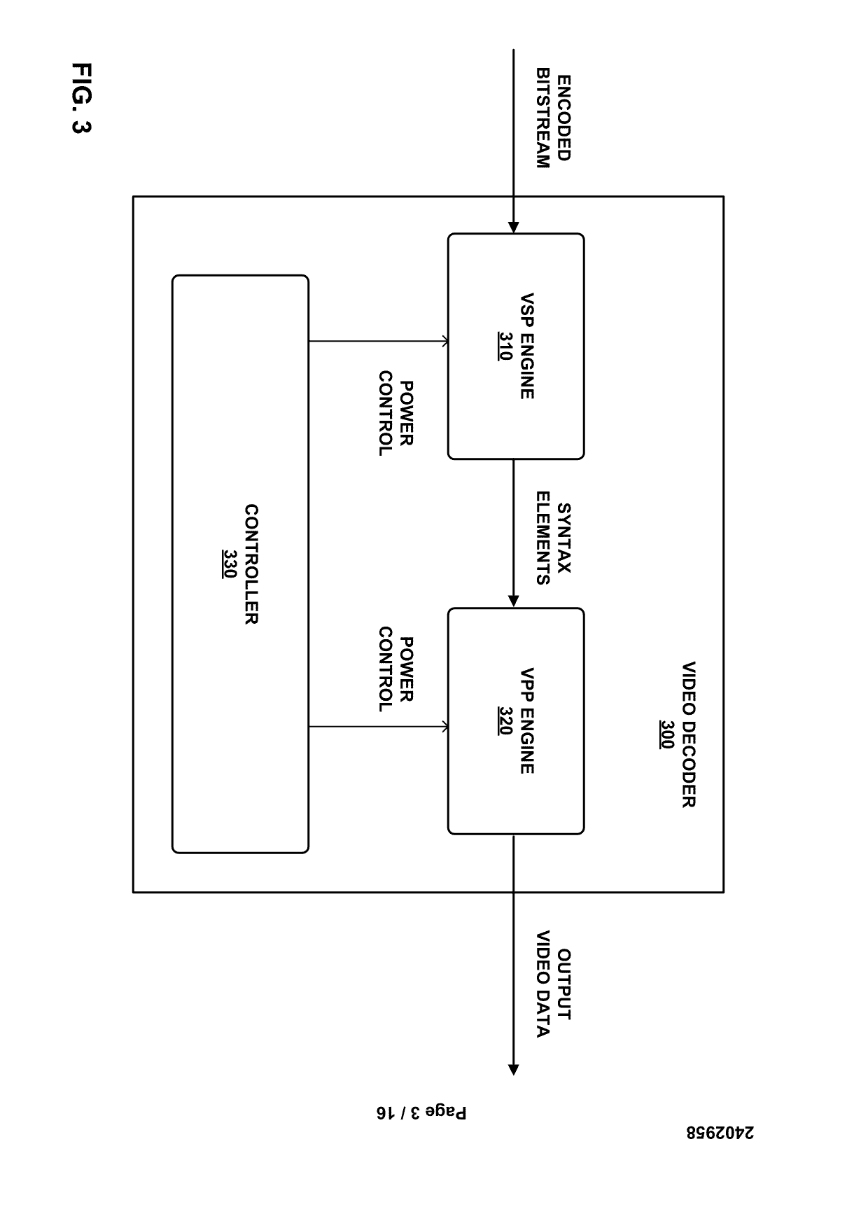

FIG. 3 is a block diagram illustrating an example video decoder that may perform the techniques of this disclosure. Video decoder 300 perform the inverse operation of video encoder 200 of FIG. 2. In the example of FIG. 3, video decoder 300 includes VSP engine 310, VPP engine 320, and controller 330. VSP engine 310 is configured to process an encoded video bitstream to produce syntax elements. That is, VSP engine 310 may perform entropy decoding, such as CABAC decoding, to recover the syntax elements encoded in the encoded video bitstream. Again, like VSP engine 220 of FIG. 2, VSP engine 310 operates on the bit or “bin” level. The processing speed of VSP engine 310 engine is typically measured in terms of a bitrate (e.g., Mbps, M bits per second).

VPP engine 210 may perform pixel level video decoding processes described above, such as prediction, inverse transformation, dequantization, filtering. The output of VPP engine 320 is output video data in the form of decoded frames. In some examples, video decoder 300 may include a plurality of VPP engines, where the plurality of VPP engines may be configured to operate on video data of a frame in parallel. For example, each VPP engine may operate on an LCU row of video data.

VPP engine 320 may process video data at the pixel level. As such, the processing speed of VPP engine 320 may be described as a pixel rate (e.g., MPps, M Pixels per second). Again, VSP engine 310 is typically configured to operate at a faster speed than VPP engine 320. VPP engine 320 and VSP engine 310 may exchange data through one or more memories or buffers, including faster on-chip buffers, or buffers in external memory (e.g., double data rate (DDR) RAM).

Video decoder 300 may further include a controller 330 configured to control the power state of VPP engine 320 and VSP engine 310. Controller 330 may operate according to firmware and/or may execute a software driver. As described above, controller 330 may be configured to independently power on and off VPP engine 320 and VSP engine 310. The techniques described below focus on how VSP engine 310 may be selectively powered off when idle.

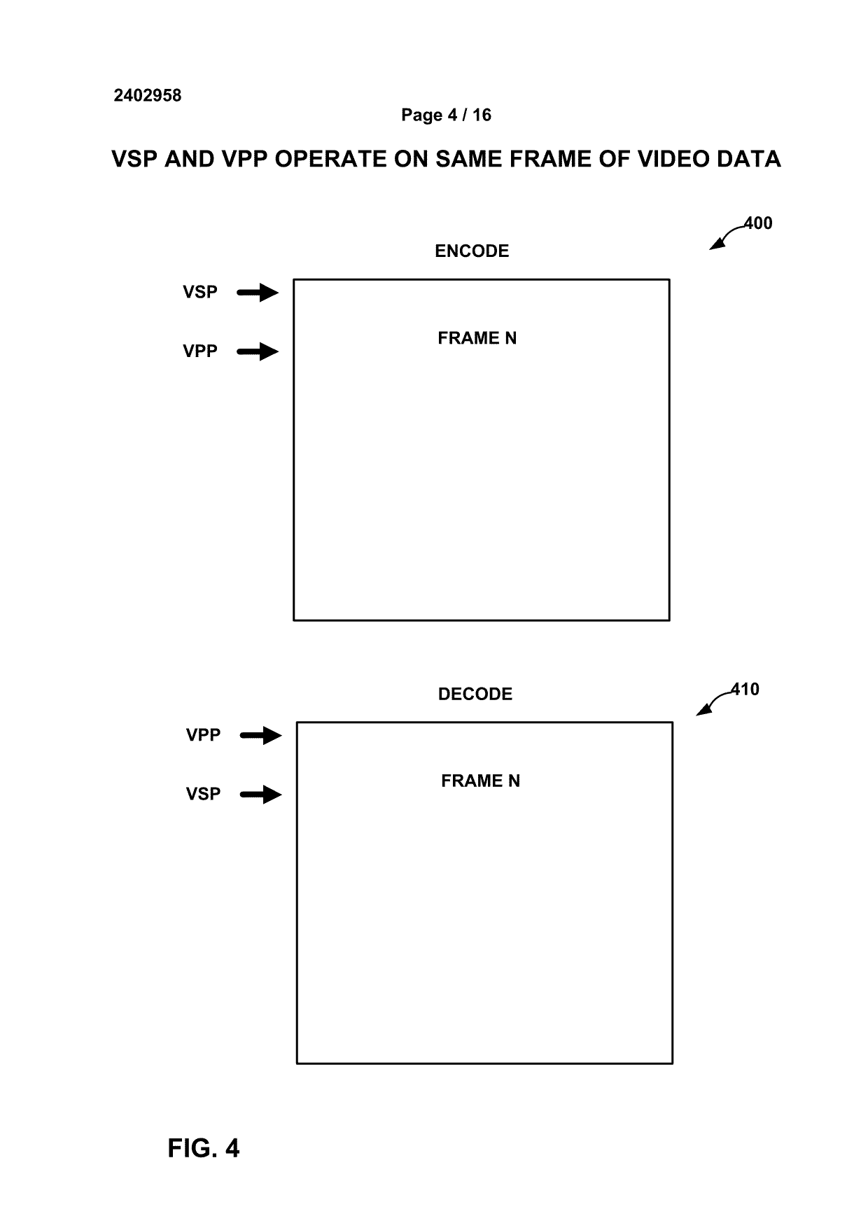

FIG. 4 illustrates example use cases of a VSP engine and a VPP engine operating on the same frame of video data. In scenario 400, video encoder 200 uses a VSP engine and a VPP engine to process a Frame N of video data. Scenario 400 may be called a same frame mode of video encoding. In scenario 400, the VPP engine and the VSP engine are configured to operate on the same frame of video data. That is, the VPP engine starts encoding Frame N and produces syntax elements (e.g., one or more LCU rows of syntax elements) that are stored in memory. After a certain amount of syntax elements are produced (e.g., one or more LCU rows of syntax element data), the VSP engine takes the syntax elements as input and produces the encoded video bitstream. Again, communication of data between the VPP engine and the VSP engine may be though on-chip memory or external DDR memory. In some examples, scenario 400 may use on-chip memory, as the amount of data produced and consumed within a single frame is relatively small.

In scenario 410, video decoder 300 uses a VSP engine and a VPP engine to process a Frame N of video data. Scenario 410 may be called a same frame mode of video decoding. In scenario 410, the VPP engine and the VSP engine are configured to operate on the same frame of video data. That is, the VSP engine starts decoding Frame N and decodes syntax elements (e.g., one or more LCU rows of syntax elements) that are stored in memory. After a certain amount of syntax elements are decoded (e.g., one or more LCU rows of syntax element data), the VPP engine takes the syntax elements as input and produces decoded video data. Again, communication of data between the VPP engine and the VSP engine may be though on-chip memory or external DDR memory. In some examples, scenario 400 may use on-chip memory, as the amount of data produced and consumed within a single frame is relatively small.

Scenario 400 and scenario 410 may be particularly useful for low latency video coding applications, where quicker changes in output provide for a better user experience. Such applications may include AR or XR applications that react to user interaction, such that immediate feedback is more beneficial.

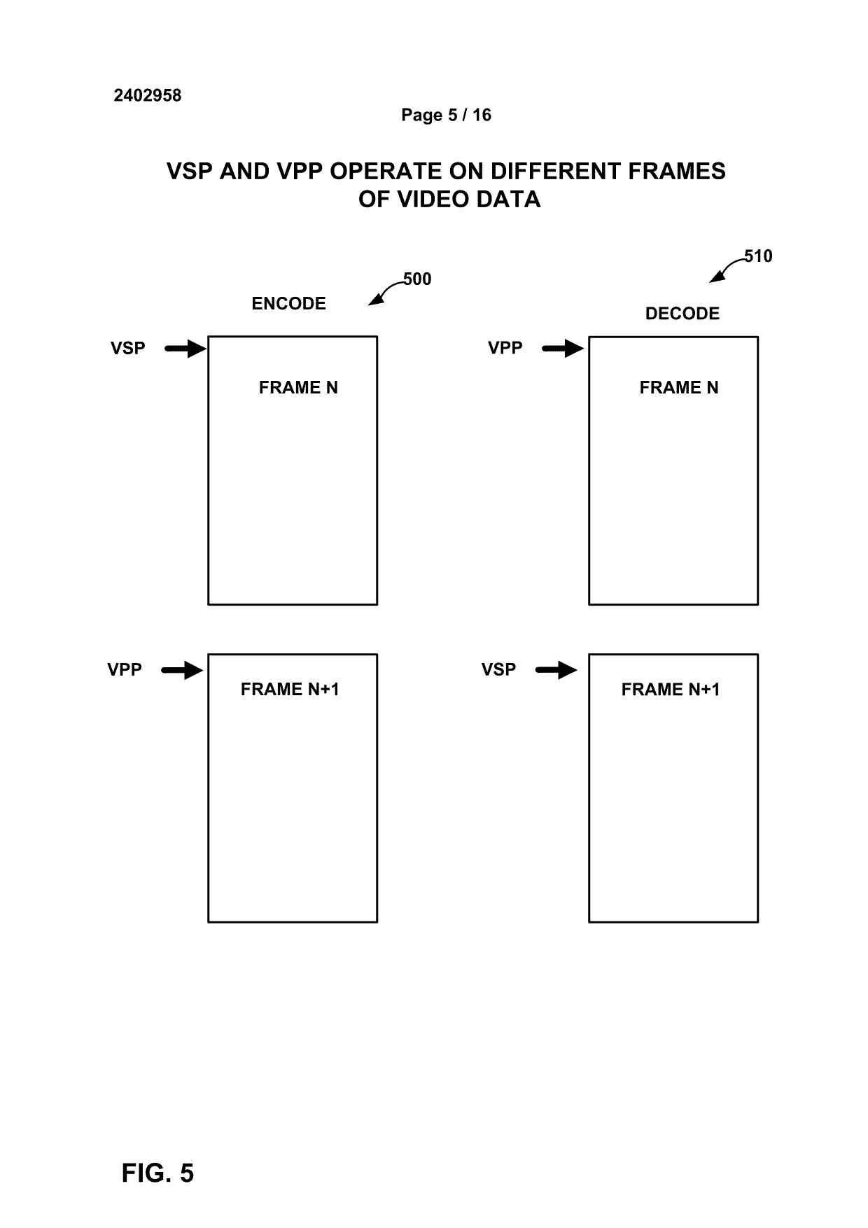

FIG. 5 illustrates example use cases of a VSP engine and a VPP engine operating on different frames of video data. In scenario 500, video encoder 200 uses a VSP engine and a VPP engine to encode a frame N of video data and a frame N+1 of video data substantially in parallel. That is, the VSP engine and the VPP engine are configured to operate on different frames of video data in parallel. While scenario 500 shows the VPP engine operating one frame ahead (e.g., at Frame N+1) of the VSP engine, in other examples, the VPP engine may operate several frames ahead of the VSP engine. Scenario 500 may be called a different frame mode of video encoding.

In scenario 500, the VPP engine completely encodes (e.g., produces syntax elements) for the entirety of Frame N and then begins encoding Frame N+1. When the VPP engine starts encoding Frame N+1, the VSP engine begins consuming the syntax elements for Frame N produced by the VPP engine and produces an encoded video bitstream for Frame N. Again, communication of data between the VPP engine and the VSP engine may be though on-chip memory or external DDR memory. In some examples, scenario 500 may use DDR memory, as the amount of data produced and consumed for one or more entire frames of video data may be relatively large.

In scenario 510, video decoder 300 uses a VSP engine and a VPP engine to decode a frame N of video data and a frame N+1 of video data substantially in parallel. That is, the VSP engine and the VPP engine are configured to operate of different frames of video data in parallel. While scenario 510 shows the VSP engine operating one frame ahead (e.g., at Frame N+1) of the VPP engine, in other examples, the VSP engine may operate several frames ahead of the VPP engine. Scenario 510 may be called a different frame mode of video decoding.

In scenario 510, the VSP engine completely decodes (e.g., produces syntax elements) for the entirety of Frame N and then begins decoding Frame N+1. When the VSP engine starts decoding Frame N+1, the VPP engine begins consuming the syntax elements for Frame N produced by the VSP engine and produces decoded video data for Frame N. Again, communication of data between the VPP engine and the VSP engine may be though on-chip memory or external DDR memory. In some examples, scenario 510 may use DDR memory, as the amount of data produced and consumed for one or more entire frames of video data may be relatively large.

Scenario 500 and scenario 510 may be particular useful for video applications where low latency is not as beneficial, but consistent frame rates are desired. Such applications may include normal video playback, or AR or XR applications where the video is displayed very close to a user’s eyes, such that changes in frame rate become more noticeable.

In general, video encoder 200 and video decoder 300 may include a VSP engine configured to process the video data at a syntax element level, a VPP engine configured to process the video data at a pixel level, and a controller. The controller is configured to control a power of the VSP engine based on the VSP engine being idle. Specific examples of how the controller may power on and off the VSP engine in the scenarios of FIGS. 4 and 5 are described in more detail below.

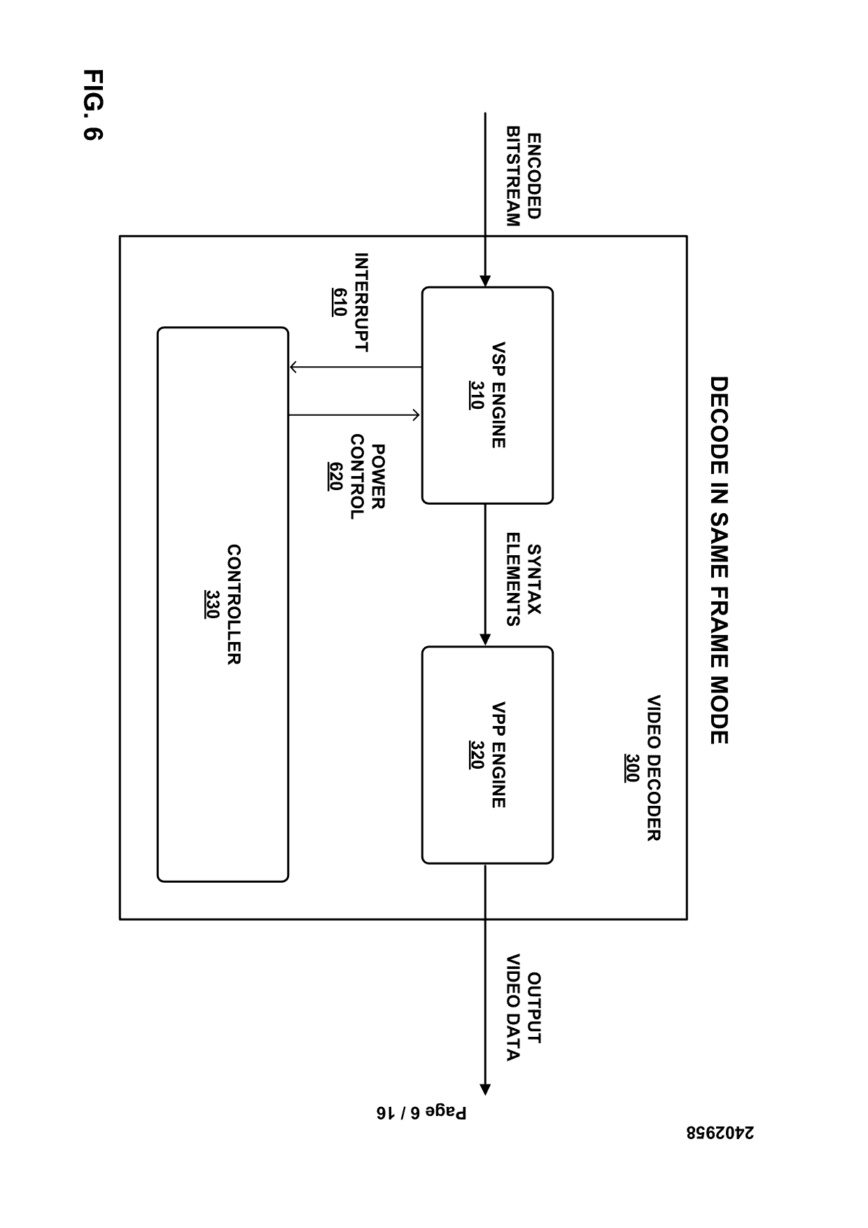

FIG. 6 is a block diagram illustrating an example video decoder in a same frame mode in accordance with one example of the disclosure. FIG. 6, shows video decoder 300 configured to decode video data in a same frame mode. As discussed above, VSP engine 310 and VPP engine 320 may operate on the same frame of video data. VSP engine 310 may receive an encoded video bitstream and then produce syntax elements that are stored in memory and may be consumed by VPP engine 320 to produce the output video data. Because VSP engine 310 processes data much faster than VPP engine 320, VSP engine 310 may finish decoding syntax elements for a frame well before VPP engine 320 has finished producing the output video data.

As such, VSP engine 310 may be configured to send an interrupt 610 (e.g., VSP_DONE) to controller 330 when VSP engine 310 has finished decoding syntax elements for the frame. Based on interrupt 610, controller 330 may send power control 620 to VSP engine 310 that powers off VSP engine 310. Controller 330 may then send another power control 620 to VSP engine 310, powering back on VSP engine 310 when VPP engine 320 has finished processing the frame. VSP engine 310 may then begin processing the next frame. In this way, non-active leakage power that would normally be lost while VSP engine 310 sits idle waiting for VPP engine 320 to finish is substantially avoided.

In summary, in the example of FIG. 6, VSP engine 310 and the VPP engine 320 are configured to decode video data, and are configured to process a same frame of the video data. VSP engine 310 is configured to start processing the same frame of the video data before VPP engine 320. VSP engine 310 is further configured to send interrupt 610 to controller 330 when finished processing the same frame of the video data. Controller 330 is configured to power off VSP engine 310 based on interrupt 610, or power back on VSP engine 310 when VPP engine 320 has finished processing the frame.

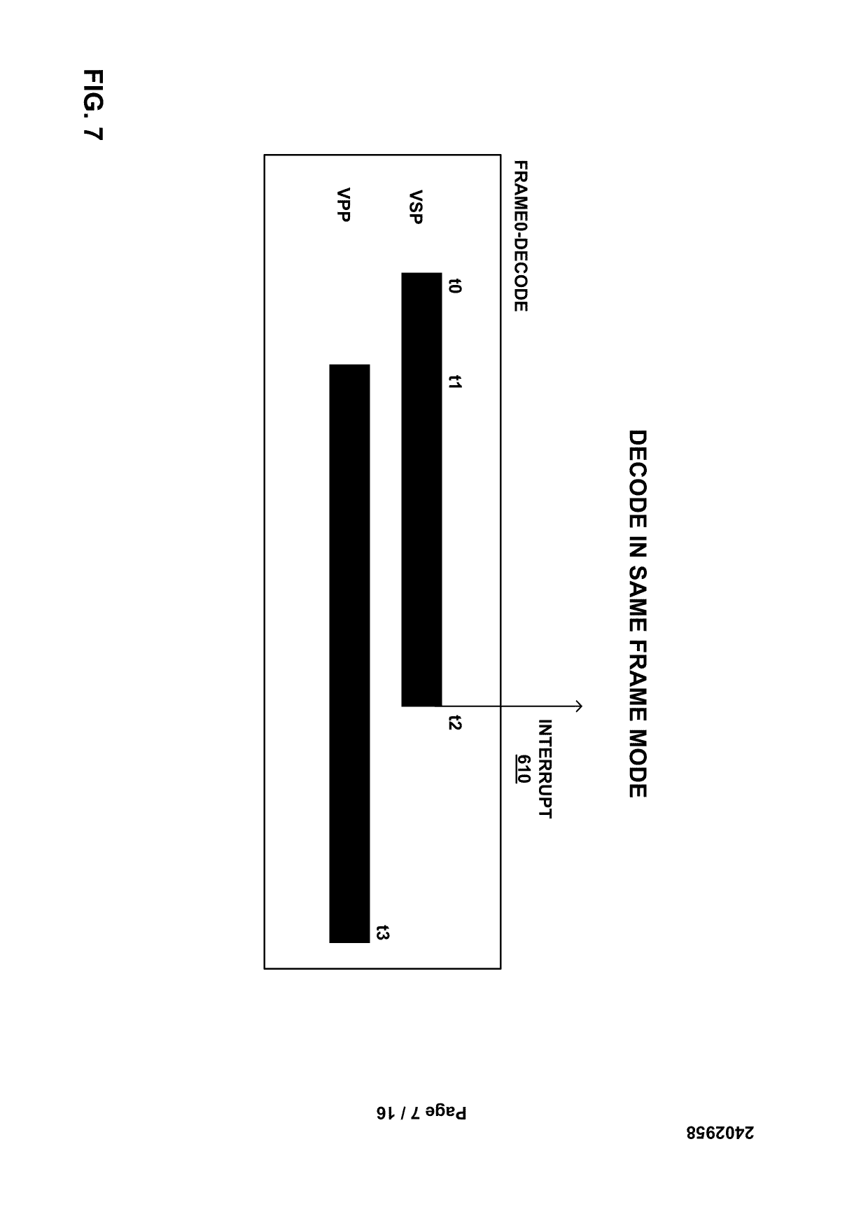

FIG. 7 is a timing diagram illustrating an example of same frame video decoding in accordance with the example of FIG. 6. At time t0, VSP engine 310 starts decoding the encoded frame of video data. VPP engine 320 starts decoding the syntax elements produced by VSP engine 310 at time t1. Time t1 may correspond to the time needed for VSP engine 310 to produce one or more LCU rows (e.g., 1, 2, 4, or more rows) of syntax elements for VPP engine 320 to decode.

VSP engine 310 completes the decoding of the encoded frame of video data at time t2 and sends interrupt 610 to controller 330. Controller 330 then powers off VSP engine 310. VPP engine 320 continues processing the syntax elements produced by VSP engine 310 until time t3. At time t3, controller 330 may power on VSP engine 310 and VSP engine 310 may begin decoding the next frame of video data.

The relative timing shown in FIG. 7 represents a VSP engine that is approximately twice as fast as the VPP engine. As such, by using the interrupt when the VSP engine is finished, controller 330 may cause VSP engine 310 to be powered off for approximately 50% of the time it takes to completely process the frame by both the VSP engine and the VPP engine. This substantially reduces non-active leakage power from the VSP engine. In situations where the VSP processes even faster relative to the VPP engine, even more non-active leakage power can be saved.

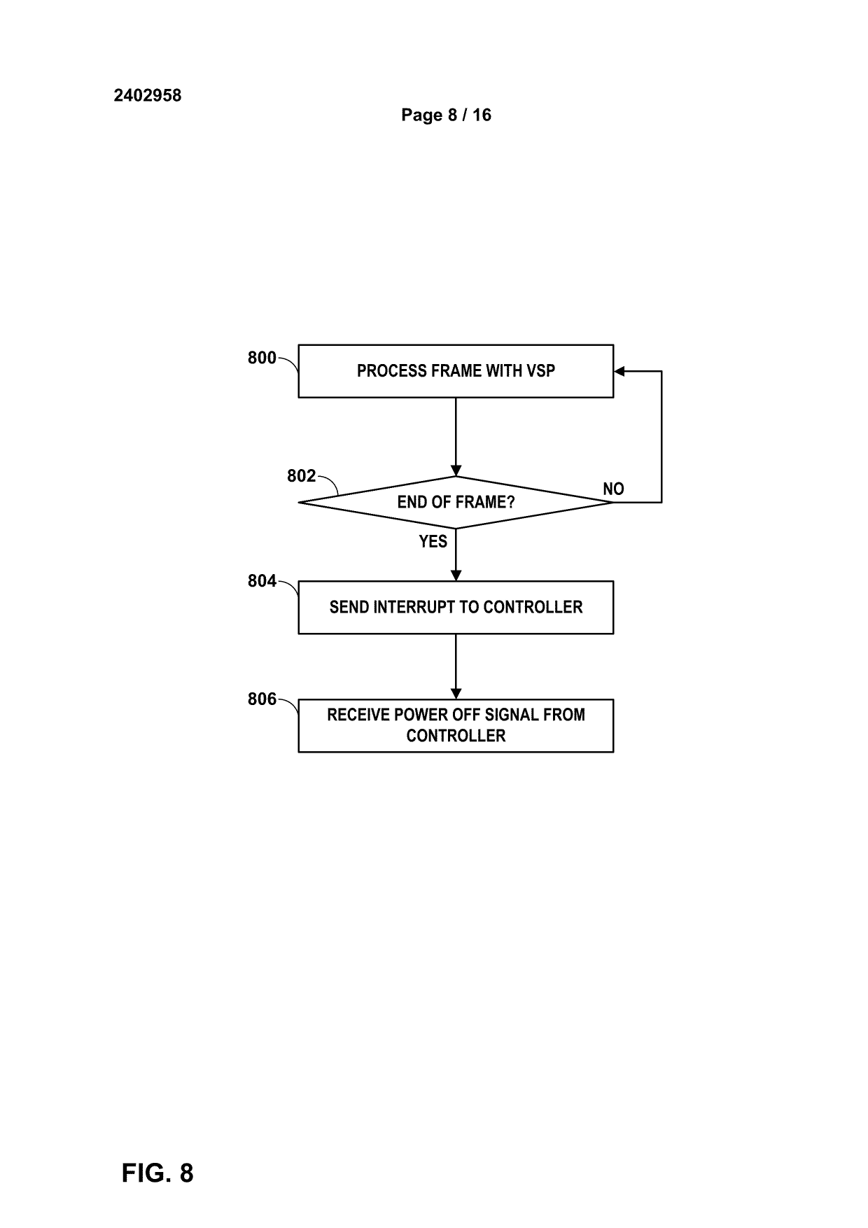

FIG. 8 is a flowchart illustrating an example of same frame video decoding in accordance with one example of the disclosure. Video decoder 300 may process a frame of video data with VSP engine 310 (800). VSP engine 310 may determine if it is at the end of the frame (802). If yes at 802, VSP engine 310 may send an interrupt to controller 330 (804). VSP engine 310 may then receive a power off signal from controller 330 and may power off (806). If no at 802, VSP engine may continue to process the frame (800).

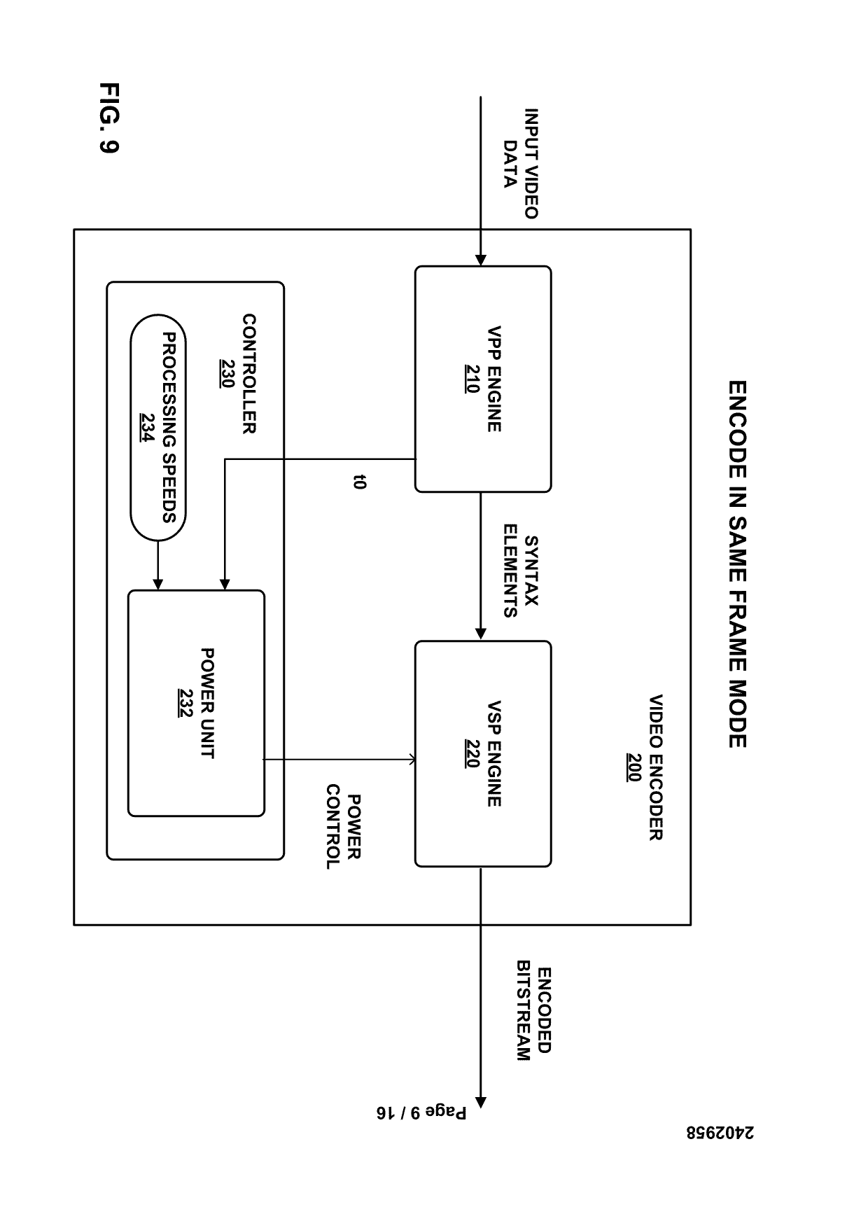

FIG. 9 is a block diagram illustrating an example video encoder in a same frame mode in accordance with one example of the disclosure. FIG. 9, shows video encoder 200 configured to encode video data in a same frame mode. As discussed above, VSP engine 220 and VPP engine 210 may operate on the same frame of video data. VPP engine 210 may receive a frame of input video data and encode the frame to produce syntax elements that are stored in memory and may be consumed by VSP engine 220 to produce the encoded video bitstream. Because VSP engine 220 processes data much faster than VPP engine 210, controller 230 may be configured to delay the time at which VSP engine 220 is powered on such that VSP engine 220 and VPP engine 210 finish processing the frame at approximately the same time. Power unit 232 of controller 230 may be configured to use the time at which VPP engine 210 starts processing the frame (e.g., time t0), as well as the relative processing speeds 234, to estimate a time at which to turn on VSP engine 220.

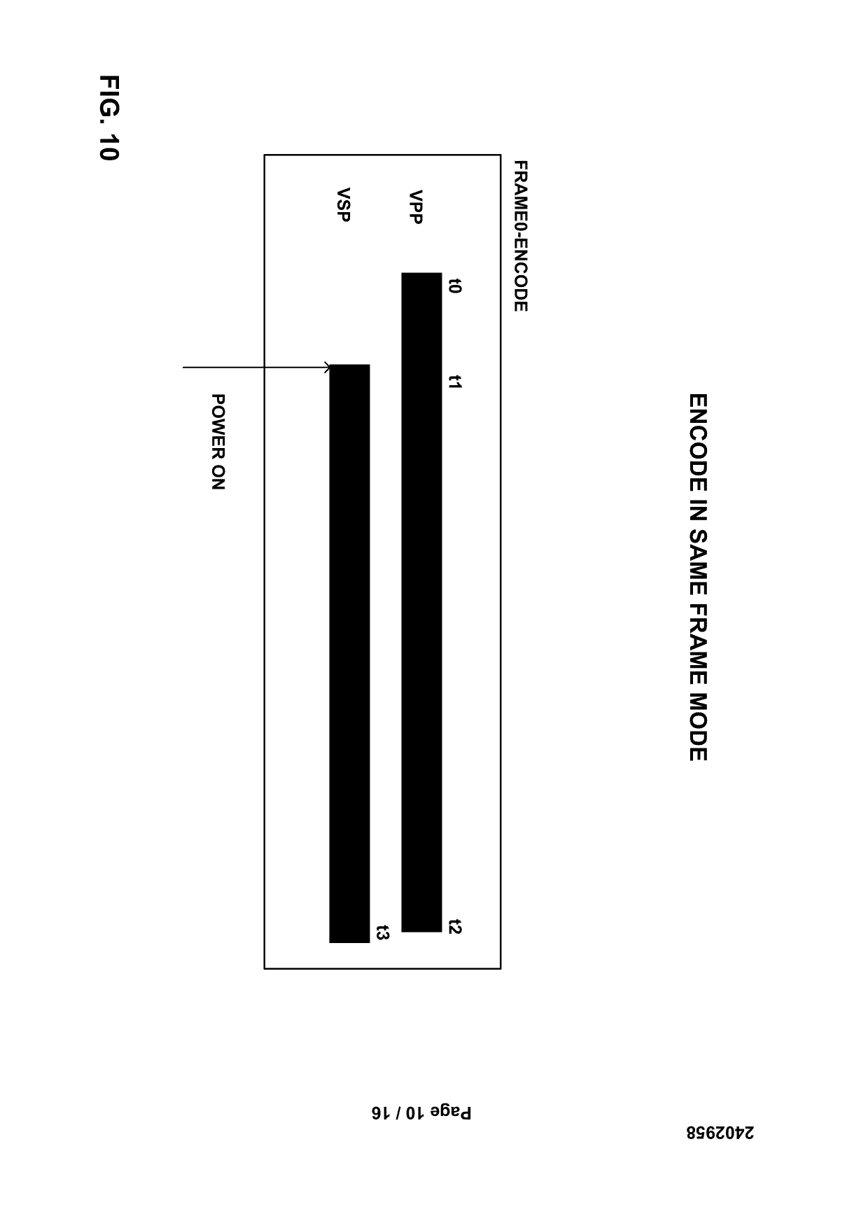

FIG. 10 is a timing diagram illustrating an example of same frame video encoding in accordance with one example of the disclosure. VPP engine 210 starts processing the frame at time t0. VPP engine 210 will finish processing the frame at time t2. As noted above, the processing speed of the VPP engine 210 is measured in terms of a pixel rate (e.g., Y-MPps). Given the processing speed of VPP engine 210 and the resolution (e.g., number (N) of pixels) of the input frame of video data, the completion time for VPP engine 210 to finish the frame may be determined as: (N) /(Y) = the VPP completion time C1 = (t2-t0).

VSP engine 220 will starting processing syntax elements produced by VPP engine 210 at some time after time t0 (e.g., time t1) and will complete processing at time t3. The processing speed of the VSP engine 220 is measured in terms of a bit rate (e.g., X-MBps). Given the processing speed of VSP engine 220 and the bit budget for the frame (e.g., number (M) of bits available to encode the frame), the completion time for VSP engine 220 to finish the frame may be determined as: (M)/(X) = the VSP completion time C0 = (t3-t1).

Controller 230 may be configured to determine the time t1 at which to power on VSP engine 220 based on the relative processing speeds of VPP engine 210 and VSP engine 220. That is, when VPP engine 210 starts processing the frame at time t0, VSP engine 220 is powered off. Controller 230 may determine a time t1 at which to power on VSP engine 220 such that time t2 and time t3 are approximately the same.

In one example, controller 230 may use the following techniques to determine the time to start VSP engine 220. When video encoder 200 receives a frame to encode, given a target bitrate and a frame resolution, controller 230 may determine the frame size in terms of bits and pixels (M bits) and (N pixels). Since VSP engine 220 is faster than VPP engine 210, C1/C0 gives the completion time difference. As a general example, VSP engine 220 may be 2x as fast as VPP engine 210. In this case, t1 = 0.5 * C1. As a result, controller 230 powers on VSP engine 220 at time t1 (0.5*C1). Between time t0 and time t1, VSP engine 220 is powered OFF. Accordingly, VSP non-active leakage power of VSP engine 220 is reduced.

In general, it is desirable to start VSP engine 220 as late as possible, as the more time VSP engine 220 is powered off, the less non-active leakage power is lost. However, if the VSP engine 220 sits idle for too long, an on-chip memory used to store syntax elements produced by VPP engine 210 may overflow. To avoid overflowing the memory, controller 230 may start VSP engine 220 sooner. Accordingly, in a more general example, controller 230 may determine time t1 to start VSP engine 220 according to the following equation: t1 = t0 + α(C1-C0), where t1 is the time to power on the VSP engine, t0 is a time the VPP engine has started processing the same frame of video data, C0 is a completion time of the VPP engine, C1 is a completion time of the VSP engine, and α is a control parameter. The control parameter α can take on values between 0 and 1, inclusive. The larger the value of control parameter α, the longer VSP engine 220 stays powered off. A large value of control parameter α saves more power. The smaller the value of control parameter α, the shorter time VSP engine 220 stays powered off. A small value of control parameter α saves less power than large value, but may be more efficient with small on-chip memory sizes. Controller 230 may have control parameter α predefined or may determine the value of control parameter α based on the relative processing speeds as well as the amount of memory available.

Accordingly, in another example of the disclosure, VSP engine 220 and VPP engine 210 are configured to encode the video data and are configured to process a same frame of video data. VPP engine 210 is configured to start processing the same frame of the video data before the VSP engine 220. VSP engine 220 is in a power off state when VPP engine 210 starts processing the same frame of the video data. Controller 230 is configured to power on VSP engine 220 at a time after VPP engine 210 has started processing the same frame of the video data based on a relative processing speed of VPP engine 210 and the VSP engine 220.

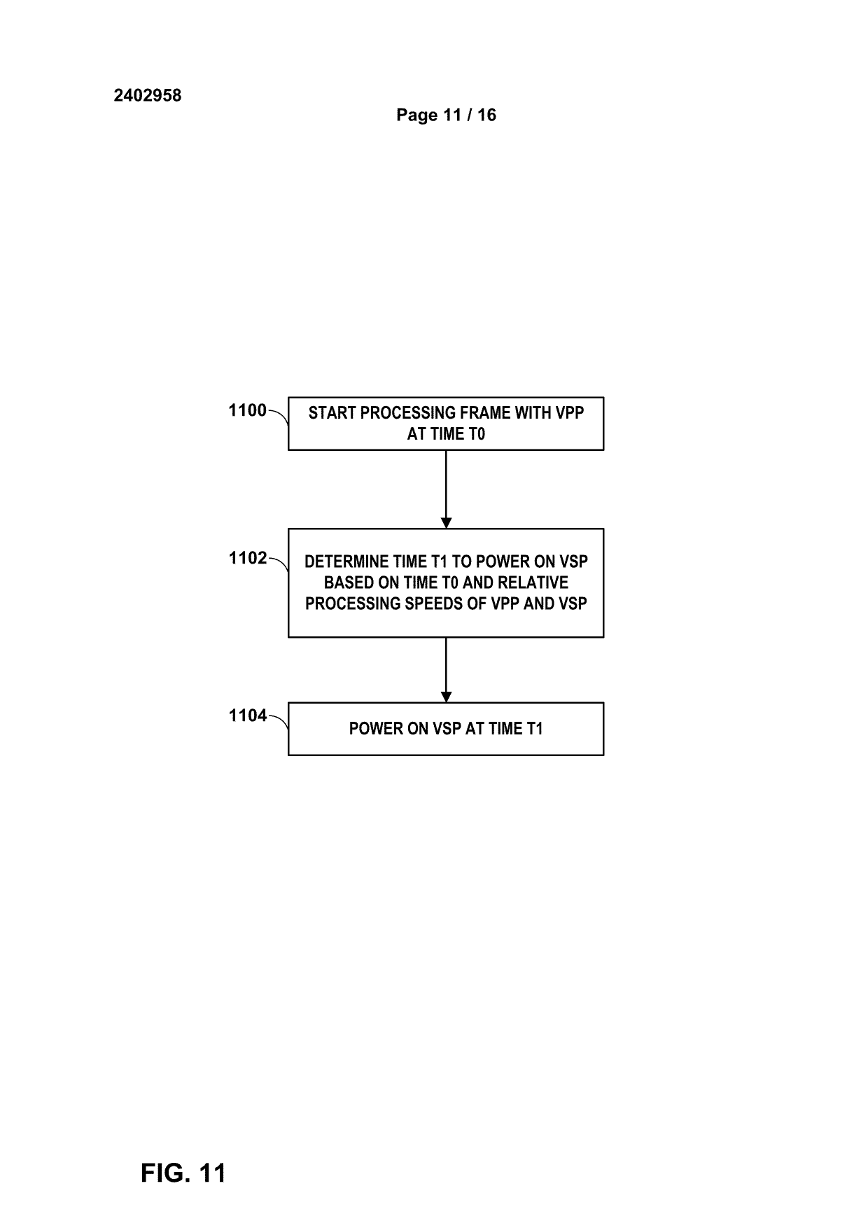

FIG. 11 is a flowchart illustrating an example of same frame video encoding in accordance with one example of the disclosure. Video encoder 200 is configured to start processing a frame of video with VPP engine 210 at time t0 (1100). Controller 230 of video encoder 200 may determine a time t1 to power on VSP engine 220 based on time t0 and the relative processing speeds of VPP engine 210 and VSP engine 220 (1102). Controller 230 may then power on VSP engine 220 at time t1 (1104).

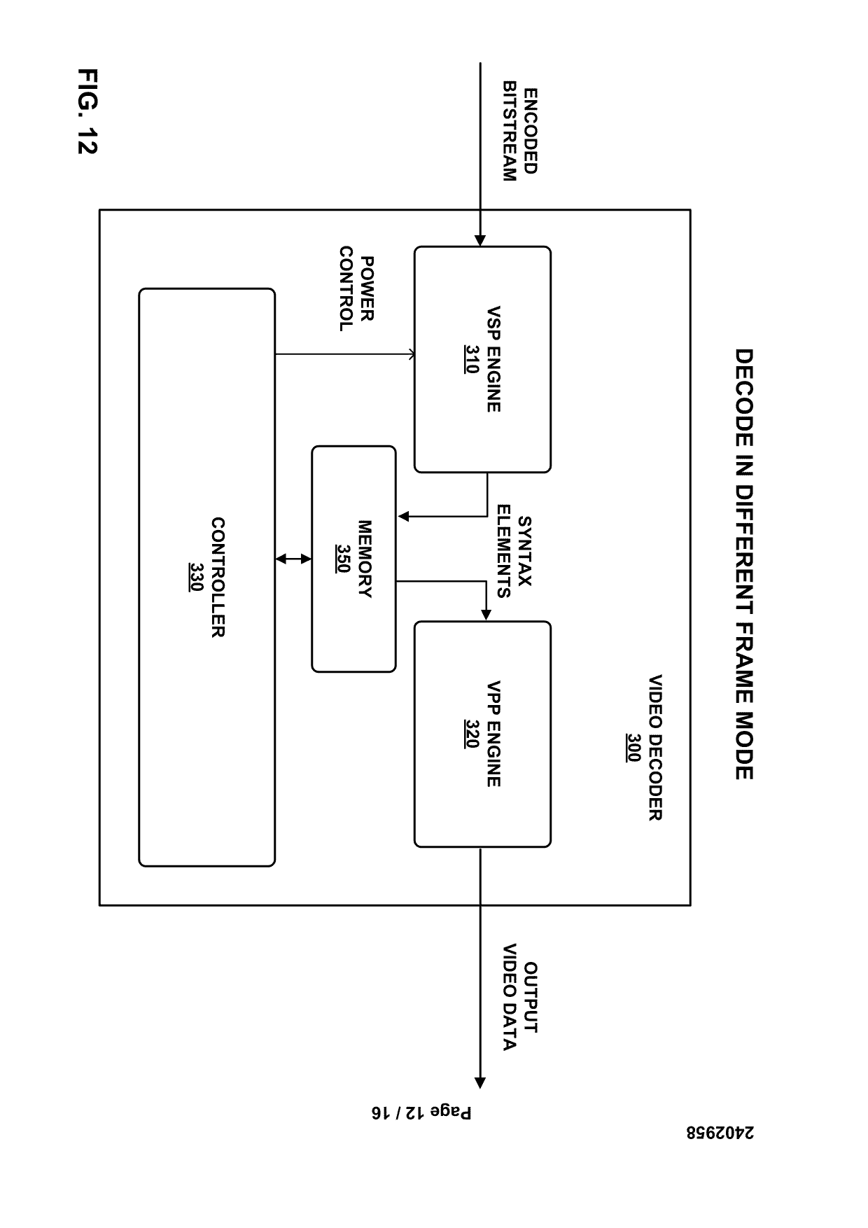

FIG. 12 is a block diagram illustrating an example video decoder in a different frame mode in accordance with one example of the disclosure. In FIG. 12, video decoder 300 is configured to decode a frame of video data in a different frame mode. As discussed above, a different frame mode may be beneficial for use cases where low latency is not as beneficial, but consistent frame rates are desired. Such applications may include normal video playback, or AR or XR applications (e.g., VR theater or VR 360) where the video is displayed very close to a user’s eyes, such that changes in frame rate become more noticeable. Such video data in a different frame mode may be encoded using constant bitrate (CBR) encoding. In constant bitrate encoding, the bitrate of encoded video data remains consistent (e.g., within a tight range) for entire the video file. In this way, decoding times remain consistent and frame rates are steady (e.g., fewer speed fluctuations).

In the example of FIG. 12, video decoder 300 may include a memory 350 between VSP engine 310 and VPP engine 320 for storing decoded syntax elements. While being shown as an on-chip memory, memory 350 may be external DDR memory in other examples. In one example, memory 350 may be implemented as a ring buffer capable of holding X number of frames of syntax element data. For example, memory 350 may be a ring buffer configured to store 6 to 10 frames of syntax element data. However, any size of ring buffer may be used.

As discussed above, in a different frame mode, VSP engine 310 processes an entire encoded frame of video data and produces a frame of decoded syntax element data before VPP engine 320 starts processing that frame. Because VSP engine 310 is considerably faster than VPP engine 320, VSP engine 310 may produce many frames of syntax element data before VPP engine 320 can consume them, thus potentially overrunning the ring buffer in memory 350. Accordingly, controller 330 may be configured to monitor memory 350 to determine how may frames of syntax element data are available for VPP engine 320.

When controller 330 determines that there are more than a first threshold (th1) number of frames of syntax element data in memory 350, controller 330 may power off VSP engine 310. This allows VPP engine 320 time to process the syntax element data without overrunning the ring buffer. As one example, if the ring buffer of memory 350 is configured to store 10 frames of syntax element data, controller 330 may power off VSP engine 310 when 6 frames of syntax element data are available to VPP engine 320 in memory 350. Of course, the threshold may be greater or smaller than 6 and may also depend on the relative speeds of VSP and VPP engines, as well as the size of the ring buffer.

Controller 330 may continue to monitor the amount of syntax element data in memory 350 while VSP engine 310 is off. When the number of frames of syntax element data is less than a second threshold (th2) number of frames (e.g., less than or equal to 2 frames of syntax element data), controller 330 may power on VSP engine 310 and repeat the process. In this way, the VSP engine 310 may be powered off for a time, reducing non-active power leakage, while avoiding overrunning or underrunning the memory.

Accordingly, in another example of the disclosure, VSP engine 310 VPP engine 320 are configured to decode the video data, and are configured to process different frames of the video data in parallel. VSP engine 310 is configured to store frames of syntax element data in a memory (e.g., a ring buffer). Controller 330 is configured to power off VSP engine 310 based on the memory having greater than a first threshold number of frames of syntax element data. Controller 330 is further configured to power on VSP engine 310 based on the memory having less than a second threshold number of frames of syntax element data.

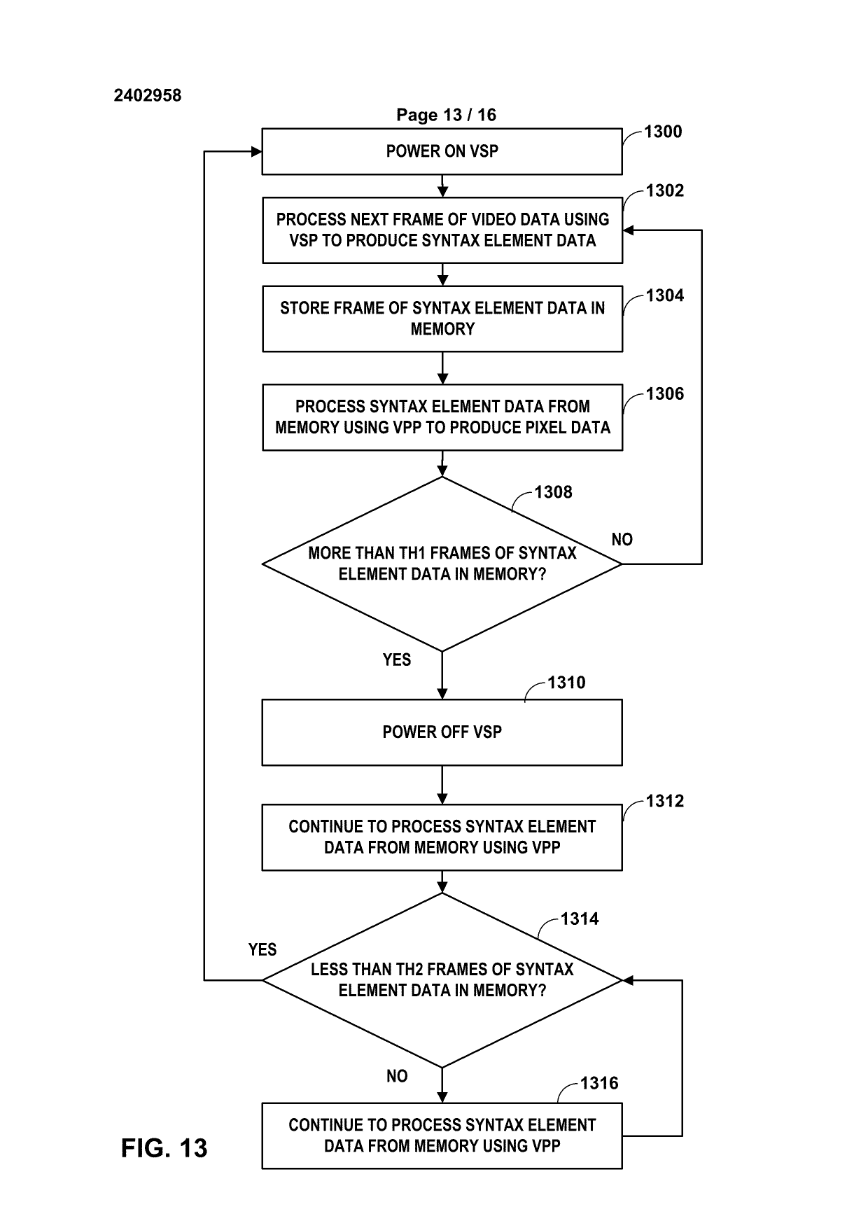

FIG. 13 is a flowchart illustrating an example of different frame video decoding in accordance with one example of the disclosure. Initially, video decoder 300 powers on VSP engine 310 (1300). Video decoder processes the next frame of video data using VSP engine 310 to produce syntax element data (1302). VSP engine 310 stores the frame of syntax element data in a memory (1304). Video decoder 300 processes the syntax element data from the memory using VPP engine 320 to produce pixel data (e.g., decoded frames) (1306).

Controller 330 monitors the memory and determines if more than a first threshold (TH1) of frames of syntax element data are in the memory (1308). If no at 1308, the process returns to 1302. If yes at 1308, controller 330 powers off VSP engine 310 (1310).

Video decoder 300 continues to process syntax element data from the memory using VPP engine 320 (1312). Controller 330 continues to monitor the memory and determines if less than a second threshold (th2) number of frames of syntax element data are in the memory (1314). If yes at 1314, controller 330 powers on VSP engine 310 (1300) and the process repeats. If no at 1314, video decoder 300 continues to process syntax element data from the memory using VPP engine 320 (1316) and the process returns to 1314.

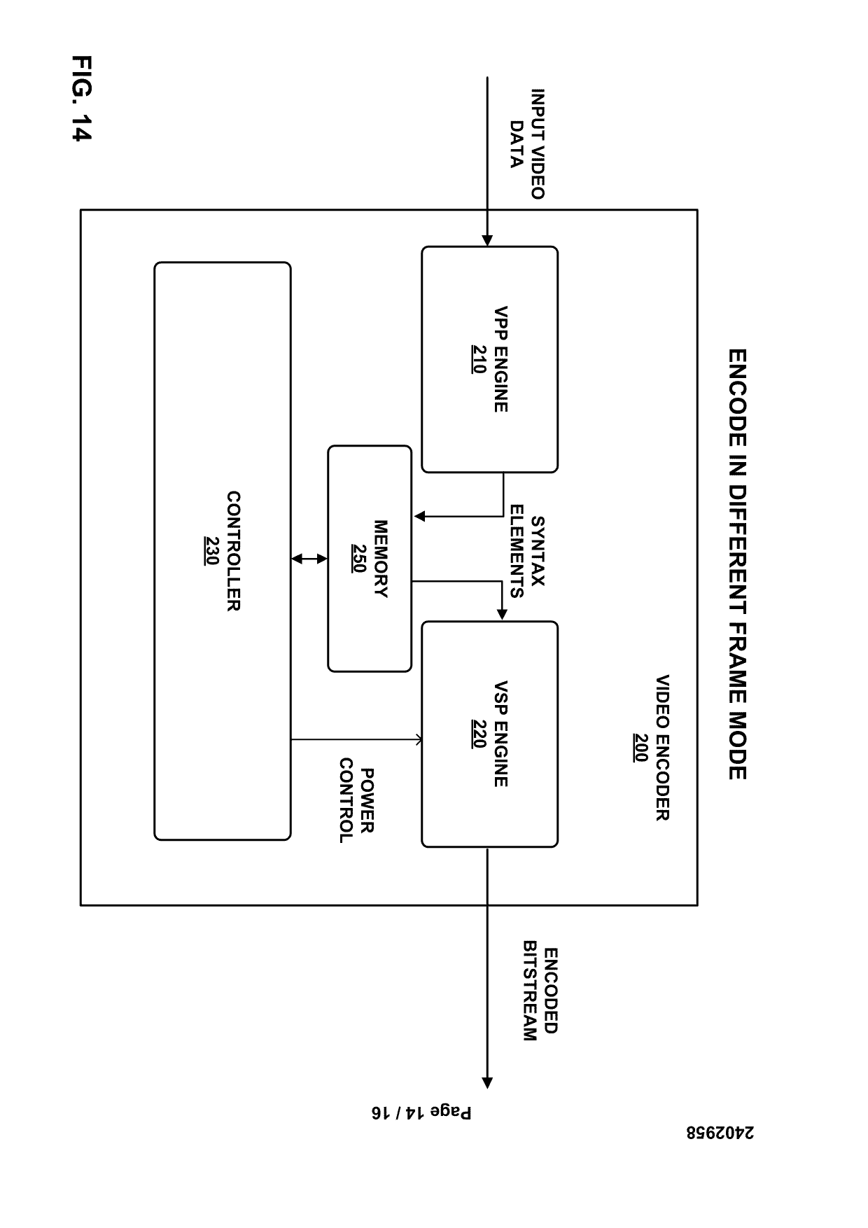

FIG. 14 is a block diagram illustrating an example video encoder in a different frame mode in accordance with one example of the disclosure. In FIG. 14, video encoder 200 is configured to encode a frame of video data in a different frame mode. The same as the decoding scenario of FIG. 12 discussed above, a different frame mode may be beneficial for use cases where low latency is not as beneficial, but consistent frame rates are desired.

In the example of FIG. 14, video encoder 200 may include a memory 250 between VPP engine 210 and VSP engine 220 for storing syntax elements. While being shown as an on-chip memory, memory 250 may be external DDR memory in other examples. In one example, memory 250 may be implemented as a ring buffer capable of holding X number of frames of syntax element data. For example, memory 250 may be a ring buffer configured to store 6 to 10 frames of syntax element data. However, any size of ring buffer may be used.

As discussed above, in a different frame mode, VPP engine 210 processes an entire input frame of video data and produces a frame of syntax element data before VSP engine 220 starts processing that frame. Because VPP engine 210 is considerably slower than VSP engine 220, VPP engine 210 may not produce enough frames of syntax element data to keep VSP engine 220 busy. Thus, VSP engine 220 may sit idle for periods of time, increasing non-active leakage power loss. Accordingly, controller 230 may be configured to monitor memory 250 to when to power on VSP engine 220.

When video encoder 200 starts to process frames of video data, controller 230 may start VSP engine 220 in a power off state. Controller 230 may monitor memory 250 to determine how many frames of syntax element data are available for processing by VSP engine 220. Controller 230 may power on VSP engine 220 when memory 250 includes more than first threshold (th1) number of frames of syntax element data (e.g., at least 2 frames). 2 frames is just one example of a threshold, and any number may be used. Controller 230 may continue to monitor memory 250 and may power off VSP engine 220 when there are no frames of syntax element data in memory 250. As such, VSP engine 220 may remain powered off unless there are frames of syntax element data to process.

Accordingly, in another example of the disclosure, VSP engine 220 and VPP engine 210 are configured to encode the video data, and are configured to process different frames of the video data in parallel. VPP engine 210 is configured to store frames of syntax element data in the memory. Controller 230 may power on the VSP engine 220 based on the memory having greater than a first threshold number of frames of syntax element data. Controller 230 may power off the VSP engine 220 based on the memory having zero frames of syntax element data.

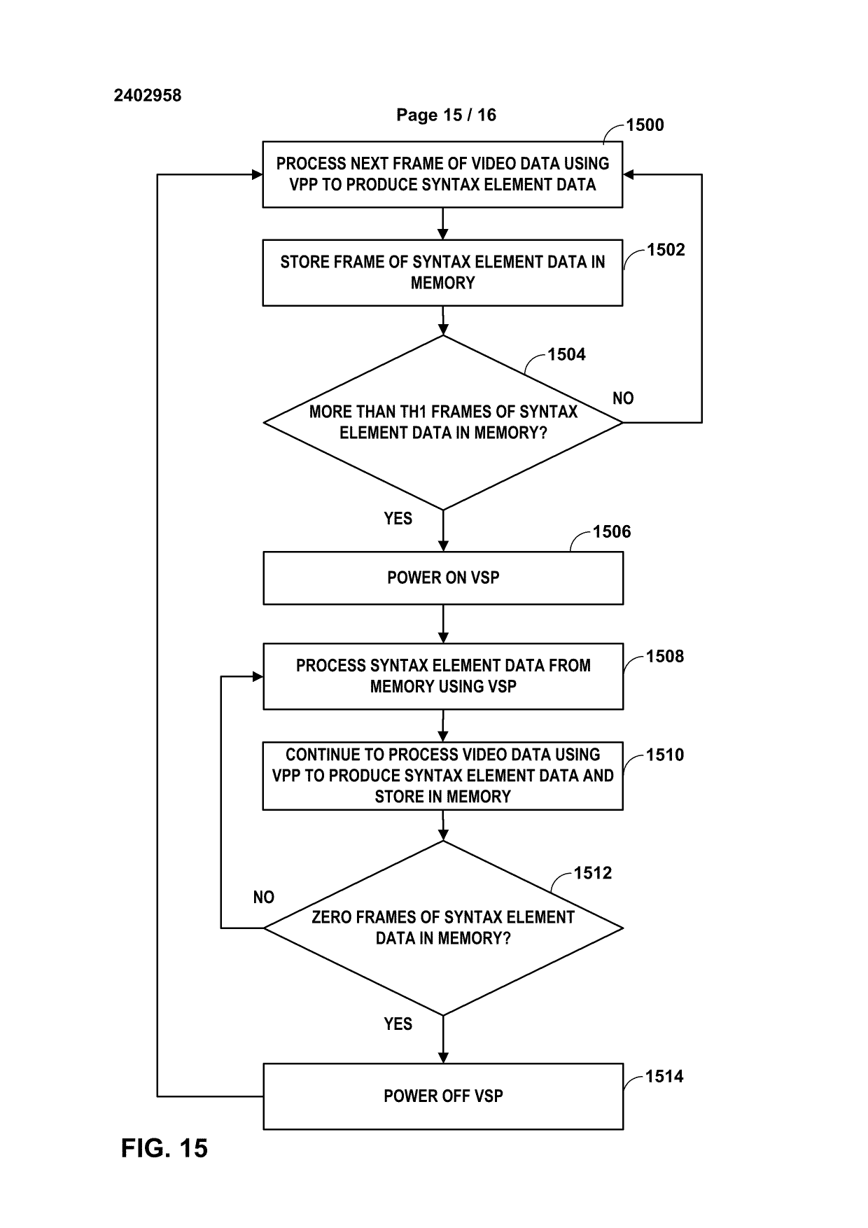

FIG. 15 is a flowchart illustrating an example of different frame video encoding in accordance with one example of the disclosure. Initially, video encoder 200 processes a next frame of video data using VPP engine 210 to produce syntax element data (1500). VSP engine 220 is power off. VPP engine 210 stores the frame of syntax element data in memory (e.g., a ring buffer) (1502). Controller 230 monitors the memory and determines if more than a first threshold (th1) number of frames of syntax element data is in the memory (1504). In one example, th1 is 1 or 2. If no at 1504, the process returns to 1500.

If yes at 1504, controller 230 powers on VSP engine 220 (1506). Video encoder 200 then process the syntax element data in the memory using VSP engine 220 to generate an encoded frame (1508). Video encoder 200 continues to process video data using VPP engine 210 to produce syntax element data and stores the syntax element data in memory (1510).

Controller 230 continues to monitor the memory and determines if zero frames of syntax element data are in memory (1512). If no at 1512, the process returns to 1508. If yes at 1512, controller 230 powers of VSP engine 220 (1514) and the process returns to 1500.

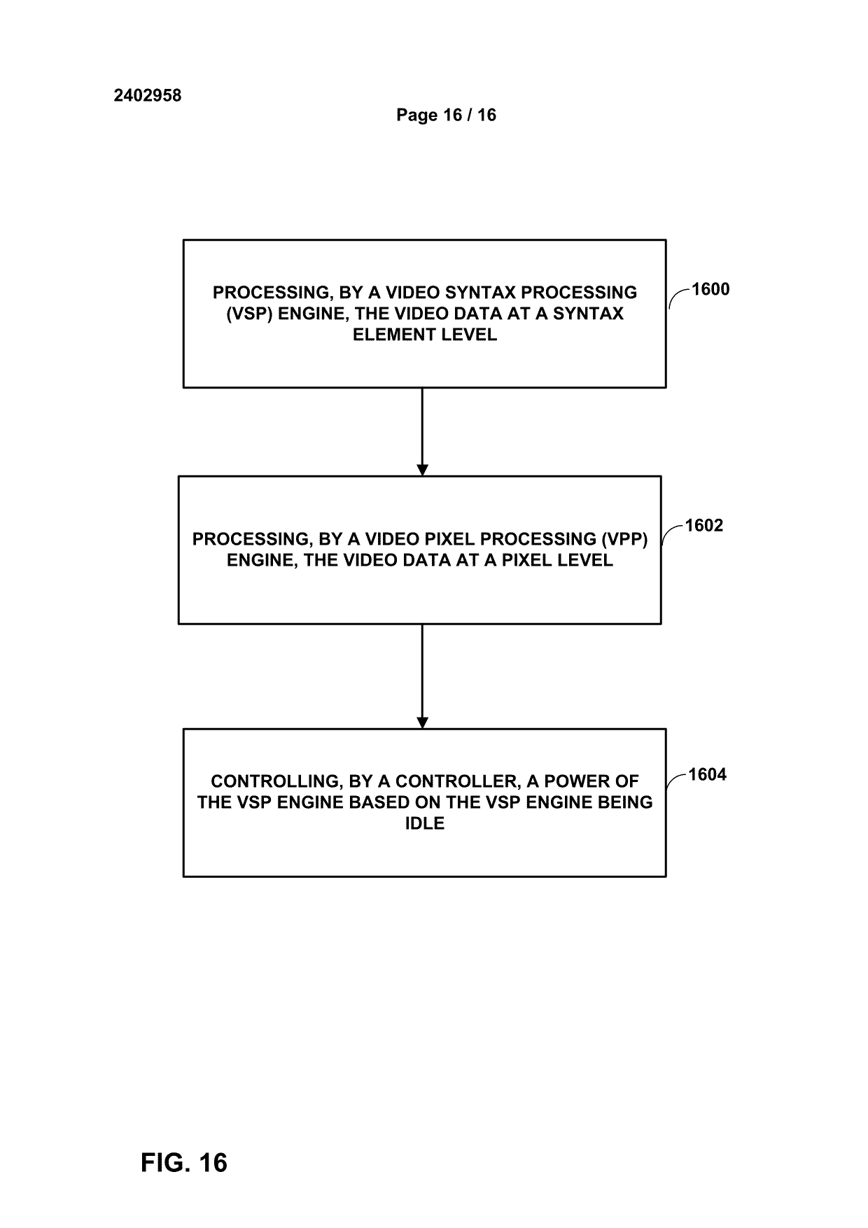

FIG. 16 is a flowchart illustrating an example method for coding video data in accordance with the techniques of this disclosure. The techniques of FIG. 16 may be performed by either video encoder 200 or video decoder 300.

In one example of the disclosure, video encoder 200 and video decoder 300 may be configured to process, by a VSP engine, video data at a syntax element level (1600), and process, by a VPP engine, the video data at a pixel level (1602). In one example, the VSP engine is configured to perform CABAC and operates at a first processing speed based on bits of data. The VPP engine is configured to perform one or more of transform processing, prediction, or filtering, and operates at a second processing speed based on pixels of data, wherein the second processing speed is slower than the first processing speed. Video encoder 200 and video decoder 300 may further be configured to control, by a controller, a power of the VSP engine based on the VSP engine being idle (1602).

In one example, the VSP engine and the VPP engine of video decoder 300 are configured to decode the video data, and the VSP engine and the VPP engine are configured to process a same frame of the video data. In this example, the VSP engine is configured to start processing the same frame of the video data before the VPP engine. The VSP engine is configured to send an interrupt to the controller when finished processing the same frame of the video data, and the controller is configured to power off the VSP engine based on the interrupt.

In another example, the VSP engine and the VPP engine of video encoder 200 are configured to encode the video data, and the VSP engine and the VPP engine are configured to process a same frame of the video data. In this example, the VPP engine is configured to start processing the same frame of the video data before the VSP engine, and the VSP engine is in a power off state when the VPP engine starts processing the same frame of the video data. The controller is configured to power on the VSP engine at a time after the VPP engine has started processing the same frame of the video data based on a relative processing speed of the VSP engine and the VPP engine. To power on the VSP engine at the time after the VPP engine has started processing the same frame of the video data based on the relative processing speed of the VSP engine and the VPP engine, the controller is configured to power on the VSP engine at the time after the VPP engine has started processing the same frame of the video data based on an equation: t1 = t0 + α(C1-C0), where t1 is the time to power on the VSP engine, t0 is a time the VPP engine has started processing the same frame of video data, α is a control parameter between 0 and 1, inclusive, C0 is a completion time of the VSP engine, and C1 is a completion time of the VPP engine.

In another example, video decoder 300 further includes a memory configured to store syntax element data generated by the VSP engine. In this example, the VSP engine and the VPP engine are configured to decode the video data, and the VSP engine and the VPP engine are configured to process different frames of the video data in parallel. The VSP engine is configured to store frames of syntax element data in the memory. The controller is configured to power off the VSP engine based on the memory having greater than a first threshold number of frames of syntax element data. The VPP engine is configured to process the frames of syntax element data in the memory, and the controller is configured to power on the VSP engine based on the memory having less than a second threshold number of frames of syntax element data.

In another example, video encoder 200 further includes a memory configured to store syntax element data generated by the VSP engine. In this example, the VSP engine and the VPP engine are configured to encode the video data, and the VSP engine and the VPP engine are configured to process different frames of the video data in parallel. The VPP engine is configured to store frames of syntax element data in the memory. The controller is configured to power on the VSP engine based on the memory having greater than a first threshold number of frames of syntax element data. The VSP engine is configured to process the frames of syntax element data in the memory, and the controller is configured to power off the VSP engine based on the memory having zero frames of syntax element data.

The following numbered clauses illustrate one or more aspects of the devices and techniques described in this disclosure.

Clause 1. An apparatus configured to code video data, the apparatus comprising: a video syntax processing (VSP) engine configured to process the video data at a syntax element level; a video pixel processing (VPP) engine configured to process the video data at a pixel level; and a controller configured to control a power of the VSP engine based on the VSP engine being idle.

Clause 2. The apparatus of Clause 1, wherein the VSP engine and the VPP engine are configured to decode the video data, wherein the VSP engine and the VPP engine are configured to process a same frame of the video data, wherein the VSP engine is configured to start processing the same frame of the video data before the VPP engine, wherein the VSP engine is configured to send an interrupt to the controller when finished processing the same frame of the video data, and wherein the controller is configured to power off the VSP engine based on the interrupt.

Clause 3. The apparatus of Clause 1, wherein the VSP engine and the VPP engine are configured to encode the video data, wherein the VSP engine and the VPP engine are configured to process a same frame of the video data, wherein the VPP engine is configured to start processing the same frame of the video data before the VSP engine, wherein the VSP engine is in a power off state when the VPP engine starts processing the same frame of the video data, and wherein the controller is configured to power on the VSP engine at a time after the VPP engine has started processing the same frame of the video data based on a relative processing speed of the VSP engine and the VPP engine.

Clause 4. The apparatus of Clause 3, wherein to power on the VSP engine at the time after the VPP engine has started processing the same frame of the video data based on the relative processing speed of the VSP engine and the VPP engine, the controller is configured to: power on the VSP engine at the time after the VPP engine has started processing the same frame of the video data based on an equation: t1 = t0 + α(C1-C0), where t1 is the time to power on the VSP engine, t0 is a time the VPP engine has started processing the same frame of video data, α is a control parameter between 0 and 1, inclusive, C0 is a completion time of the VSP engine, and C1 is a completion time of the VPP engine.

Clause 5. The apparatus of Clause 1, further comprising a memory configured to store syntax element data generated by the VSP engine, wherein the VSP engine and the VPP engine are configured to decode the video data, wherein the VSP engine and the VPP engine are configured to process different frames of the video data in parallel, wherein the VSP engine is configured to store frames of syntax element data in the memory, and wherein the controller is configured to power off the VSP engine based on the memory having greater than a first threshold number of frames of syntax element data.

Clause 6. The apparatus of Clause 5, wherein the VPP engine is configured to process the frames of syntax element data in the memory, and wherein the controller is configured to power on the VSP engine based on the memory having less than a second threshold number of frames of syntax element data.

Clause 7. The apparatus of Clause 1, a memory configured to store syntax element data generated by the VSP engine, wherein the VSP engine and the VPP engine are configured to encode the video data, wherein the VSP engine and the VPP engine are configured to process different frames of the video data in parallel, wherein the VPP engine is configured to store frames of syntax element data in the memory, and wherein the controller is configured to power on the VSP engine based on the memory having greater than a first threshold number of frames of syntax element data.

Clause 8. The apparatus of Clause 7, wherein the VSP engine is configured to process the frames of syntax element data in the memory, and wherein the controller is configured to power off the VSP engine based on the memory having zero frames of syntax element data.

Clause 9. The apparatus of any of Clauses 1-8, wherein the VSP engine is configured to perform context adaptive binary arithmetic coding (CABAC) and operates at a first processing speed based on bits of data, and wherein the VPP engine is configured to perform one or more of transform processing, prediction, or filtering, and operates at a second processing speed based on pixels of data, wherein the second processing speed is slower than the first processing speed.

Clause 10. The apparatus of any of Clauses 1-9, wherein the apparatus is a mobile communications device.

Clause 11. A method of coding video data, the method comprising: processing, by a video syntax processing (VSP) engine, the video data at a syntax element level; processing, by a video pixel processing (VPP) engine, the video data at a pixel level; and controlling, by a controller, a power of the VSP engine based on the VSP engine being idle.

Clause 12. The method of Clause 11, wherein the VSP engine and the VPP engine are configured to decode the video data, and wherein the VSP engine and the VPP engine are configured to process a same frame of the video data, the method further comprising: start processing, by the VSP engine, the same frame of the video data before the VPP engine; sending, by the VSP engine is configured, an interrupt to the controller when finished processing the same frame of the video data; and powering off, by the controller, the VSP engine based on the interrupt.

Clause 13. The method of Clause 11, wherein the VSP engine and the VPP engine are configured to encode the video data, and wherein the VSP engine and the VPP engine are configured to process a same frame of the video data, the method further comprising: start processing by the VPP engine, the same frame of the video data before the VSP engine, wherein the VSP engine is in a power off state when the VPP engine starts processing the same frame of the video data; and powering on, by the controller, the VSP engine at a time after the VPP engine has started processing the same frame of the video data based on a relative processing speed of the VSP engine and the VPP engine.

Clause 14. The method of Clause 13, wherein powering on, by the controller, the VSP engine at the time after the VPP engine has started processing the same frame of the video data based on the relative processing speed of the VSP engine and the VPP engine comprises: powering on, by the controller the VSP engine at the time after the VPP engine has started processing the same frame of the video data based on an equation: t1 = t0 + α(C1-C0), where t1 is the time to power on the VSP engine, t0 is a time the VPP engine has started processing the same frame of video data, α is a control parameter between 0 and 1, inclusive, C0 is a completion time of the VSP engine, and C1 is a completion time of the VPP engine.

Clause 15. The method of Clause 11, wherein the VSP engine and the VPP engine are configured to decode the video data, and wherein the VSP engine and the VPP engine are configured to process different frames of the video data in parallel, the method further comprising: storing, by the VSP engine, frames of syntax element data in a memory; and powering off, by the controller, the VSP engine based on the memory having greater than a first threshold number of frames of syntax element data.

Clause 16. The method of Clause 15, further comprising: processing, by the VPP engine, the frames of syntax element data in the memory; and powering on, by the controller, the VSP engine based on the memory having less than a second threshold number of frames of syntax element data.

Clause 17. The method of Clause 11, wherein the VSP engine and the VPP engine are configured to encode the video data, and wherein the VSP engine and the VPP engine are configured to process different frames of the video data in parallel, the method further comprising: storing, by the VPP engine, frames of syntax element data in a memory; and powering on, by the controller, the VSP engine based on the memory having greater than a first threshold number of frames of syntax element data.

Clause 18. The method of Clause 17, further comprising: processing, by the VSP engine, the frames of syntax element data in the memory; and powering off, by the controller, the VSP engine based on the memory having zero frames of syntax element data.

Clause 19. The method of any of Clauses 11-18, wherein the VSP engine is configured to perform context adaptive binary arithmetic coding (CABAC) and operates at a first processing speed based on bits of data, and wherein the VPP engine is configured to perform one or more of transform processing, prediction, or filtering, and operates at a second processing speed based on pixels of data, wherein the second processing speed is slower than the first processing speed.

Clause 20. An apparatus configured to code video data, the apparatus comprising: means for processing the video data at a syntax element level; means for processing the video data at a pixel level; and means for controlling a power of the means for processing the video data at a syntax element level based on the means for processing the video data at a syntax element level being idle.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus configured to code video data, the apparatus comprising:
a video syntax processing (VSP) engine configured to process the video data at a syntax element level;
a video pixel processing (VPP) engine configured to process the video data at a pixel level; and
a controller configured to control a power of the VSP engine based on the VSP engine being idle.

2. The apparatus of claim 1,
wherein the VSP engine and the VPP engine are configured to decode the video data,
wherein the VSP engine and the VPP engine are configured to process a same frame of the video data,
wherein the VSP engine is configured to start processing the same frame of the video data before the VPP engine,
wherein the VSP engine is configured to send an interrupt to the controller when finished processing the same frame of the video data, and
wherein the controller is configured to power off the VSP engine based on the interrupt.

3. The apparatus of claim 1,
wherein the VSP engine and the VPP engine are configured to encode the video data,
wherein the VSP engine and the VPP engine are configured to process a same frame of the video data,
wherein the VPP engine is configured to start processing the same frame of the video data before the VSP engine,
wherein the VSP engine is in a power off state when the VPP engine starts processing the same frame of the video data, and
wherein the controller is configured to power on the VSP engine at a time after the VPP engine has started processing the same frame of the video data based on a relative processing speed of the VSP engine and the VPP engine.

4. The apparatus of claim 3, wherein to power on the VSP engine at the time after the VPP engine has started processing the same frame of the video data based on the relative processing speed of the VSP engine and the VPP engine, the controller is configured to:
power on the VSP engine at the time after the VPP engine has started processing the same frame of the video data based on an equation: t1 = t0 + α(C1-C0), where t1 is the time to power on the VSP engine, t0 is a time the VPP engine has started processing the same frame of video data, α is a control parameter between 1-0., inclusive, C0 is a completion time of the VSP engine, and C1 is a completion time of the VPP engine.

5. The apparatus of claim 1, further comprising a memory configured to store syntax element data generated by the VSP engine,
wherein the VSP engine and the VPP engine are configured to decode the video data,
wherein the VSP engine and the VPP engine are configured to process different frames of the video data in parallel,
wherein the VSP engine is configured to store frames of syntax element data in the memory, and
wherein the controller is configured to power off the VSP engine based on the memory having greater than a first threshold number of frames of syntax element data.

6. The apparatus of claim 5, wherein the VPP engine is configured to process the frames of syntax element data in the memory, and
wherein the controller is configured to power on the VSP engine based on the memory having less than a second threshold number of frames of syntax element data.

7. The apparatus of claim 1, a memory configured to store syntax element data generated by the VSP engine,
wherein the VSP engine and the VPP engine are configured to encode the video data,
wherein the VSP engine and the VPP engine are configured to process different frames of the video data in parallel,
wherein the VPP engine is configured to store frames of syntax element data in the memory, and
wherein the controller is configured to power on the VSP engine based on the memory having greater than a first threshold number of frames of syntax element data.

8. The apparatus of claim 7, wherein the VSP engine is configured to process the frames of syntax element data in the memory, and
wherein the controller is configured to power off the VSP engine based on the memory having zero frames of syntax element data.

9. The apparatus of claim 1,
wherein the VSP engine is configured to perform context adaptive binary arithmetic coding (CABAC) and operates at a first processing speed based on bits of data,
and wherein the VPP engine is configured to perform one or more of transform processing, prediction, or filtering, and operates at a second processing speed based on pixels of data, wherein the second processing speed is slower than the first processing speed.

10. The apparatus of claim 1, wherein the apparatus is a mobile communications device.

11. A method of coding video data, the method comprising:
processing, by a video syntax processing (VSP) engine, the video data at a syntax element level;
processing, by a video pixel processing (VPP) engine, the video data at a pixel level; and
controlling, by a controller, a power of the VSP engine based on the VSP engine being idle.

12. The method of claim 11, wherein the VSP engine and the VPP engine are configured to decode the video data, and wherein the VSP engine and the VPP engine are configured to process a same frame of the video data, the method further comprising:
start processing, by the VSP engine, the same frame of the video data before the VPP engine;
sending, by the VSP engine is configured, an interrupt to the controller when finished processing the same frame of the video data; and
powering off, by the controller, the VSP engine based on the interrupt.

13. The method of claim 11, wherein the VSP engine and the VPP engine are configured to encode the video data, and wherein the VSP engine and the VPP engine are configured to process a same frame of the video data, the method further comprising:
start processing by the VPP engine, the same frame of the video data before the VSP engine, wherein the VSP engine is in a power off state when the VPP engine starts processing the same frame of the video data; and
powering on, by the controller, the VSP engine at a time after the VPP engine has started processing the same frame of the video data based on a relative processing speed of the VSP engine and the VPP engine.

14. The method of claim 13, wherein powering on, by the controller, the VSP engine at the time after the VPP engine has started processing the same frame of the video data based on the relative processing speed of the VSP engine and the VPP engine comprises:
powering on, by the controller the VSP engine at the time after the VPP engine has started processing the same frame of the video data based on an equation:
t1 = t0 + α(C1-C0), where t1 is the time to power on the VSP engine, t0 is a time the VPP engine has started processing the same frame of video data, α is a control parameter between 1-0., inclusive, C0 is a completion time of the VSP engine, and C1 is a completion time of the VPP engine.

15. The method of claim 11, wherein the VSP engine and the VPP engine are configured to decode the video data, and wherein the VSP engine and the VPP engine are configured to process different frames of the video data in parallel, the method further comprising:
storing, by the VSP engine, frames of syntax element data in a memory; and
powering off, by the controller, the VSP engine based on the memory having greater than a first threshold number of frames of syntax element data.

16. The method of claim 15, further comprising:
processing, by the VPP engine, the frames of syntax element data in the memory; and
powering on, by the controller, the VSP engine based on the memory having less than a second threshold number of frames of syntax element data.

17. The method of claim 11, wherein the VSP engine and the VPP engine are configured to encode the video data, and wherein the VSP engine and the VPP engine are configured to process different frames of the video data in parallel, the method further comprising:
storing, by the VPP engine, frames of syntax element data in a memory; and
powering on, by the controller, the VSP engine based on the memory having greater than a first threshold number of frames of syntax element data.

18. The method of claim 17, further comprising:
processing, by the VSP engine, the frames of syntax element data in the memory; and
powering off, by the controller, the VSP engine based on the memory having zero frames of syntax element data.

19. The method of claim 11,
wherein the VSP engine is configured to perform context adaptive binary arithmetic coding (CABAC) and operates at a first processing speed based on bits of data,
and wherein the VPP engine is configured to perform one or more of transform processing, prediction, or filtering, and operates at a second processing speed based on pixels of data, wherein the second processing speed is slower than the first processing speed.

20. An apparatus configured to code video data, the apparatus comprising:
means for processing the video data at a syntax element level;
means for processing the video data at a pixel level; and
means for controlling a power of the means for processing the video data at a syntax element level based on the means for processing the video data at a syntax element level being idle.
